(19) United States
(12) Patent Application Publication
(10) Pub. No.: US 2023/0388770 A1
(43) Pub. Date: Nov. 30, 2023

(54) TECHNIQUE FOR DISCOVERY IN PROXIMITY SERVICES COMPRISING DIFFERENT DISCOVERY MODELS

(71) Applicant: Telefonaktiebolaget LM Ericsson (PUBL), Stockholm (SE)

(72) Inventors: Min Wang, LULEÅ (SE); Zhang Fu, STOCKHOLM (SE); Antonino Orsino, KIRKKONUMMI (FI)

(21) Appl. No.: 18/249,568

(22) PCT Filed: Oct. 20, 2021
(86) PCT No.: PCT/EP2021/079104

§ 371 Date: Apr. 19, 2023

Related U.S. Application Data
(60) Provisional application No. 63/094,680, filed on Oct. 21, 2020.

(51) Int. Cl. H04W 8/00

(52) U.S. Cl. CPC H04W 8/005

(57) ABSTRACT

A technique for performing direct discovery between a first radio device (100-RD) and a second radio device (100-RD) according to a proximity service of a radio access technology, RAT, is described. The proximity service comprises at least two different models of the direct discovery. As to a method aspect of the technique, the direct discovery is performed according to one of the at least two different models.

### TECHNICAL FIELD

The present disclosure relates to a technique for discovery in proximity services comprising different models of the discovery. More specifically, and without 10 limitation, methods and devices are provided for performing direct discovery between a first radio device and a second radio device according to a proximity service of a radio access technology, RAT, wherein the proximity service comprises at least two different models of the direct discovery.

### BACKGROUND

The Third Generation Partnership Project (3GPP) and the Wi-Fi Alliance specify radio access technologies such as Fourth Generation Long Term Evolution (4G LTE), Fifth Generation New Radio (5G NR) and Wi-Fi, each of which supports a proximity service, which is also referred to as a PROximity-based Service (ProSe), for device-to-device (D2D) communications. For example, 3GPP has specified a ProSe for each of LTE and NR. A radio link used by the ProSe is also referred to as a sidelink (SL).

In a RAN2 meeting at 3GPP, namely RAN2 #111-e, it has been agreed that the model A 25 and the model B of the direct discovery, as specified in 3GPP LTE Releases 12 and 13, can be re-used for specifying the SL in 3GPP Release 17. For both model A and model B of the discovery, 3GPP RAN2 has decided to not introduce a specific discovery physical channel. In other words, discovery messages are transmitted using a same channel as for data transmission using a physical SL communication channel, i.e., a Physical Sidelink Shared Channel (PSSCH).

In the presence of alternative models for direct discovery and in the absence of a physical channel for discovery signaling, any radio device engaged in direct discovery would have to attempt the discovery according to each of the alternative models, which delays a direct communication, occupies radio resources and consumes power in a procedure of uncertain outcome.

### SUMMARY

Accordingly, there is a need for a technique for direct discovery of a proximity service, which reduces or eliminates arbitrariness in the presence of alternative modes of the direct discovery. An alternative or more specific object is to reduce or eliminate the latency, the signaling overhead or the power consumption caused by trying out or negotiating multiple models for the direct discovery.

As to a first method aspect, a method of performing direct discovery between a first radio device and a second radio device according to a proximity service of a radio access technology (RAT) is provided. The proximity service comprises at least two different models of the direct discovery. The method comprises or initiates a step of performing the direct discovery according to one of the at least two different models.

The technique may be applied for direct discovery in the presence of multiple (e.g., different and/or alternative) models of the direct discovery. At least some embodiments of the technique can ensure that each of the radio devices is determined as to which of the different models is to be used for the direct discovery.

The one of the at least two different models may (e.g., for a time period between the direct discovery is triggered and the performing of the direct discovery) be pre-defined in the respective radio device or determined by the respective radio device. Herein, pre-defined may encompass pre-configured or hard-coded or hard-wired in the respective radio device. Furthermore, determined may encompass selected by the respective radio device.

At least some embodiments of the technique can avoid a signaling (e.g., a negotiation) between the respective radio device and a RAN serving the respective radio device or between the first and second radio devices as to which one of the different models is to be used. Herein, the respective radio device may be at least one or each of the first radio device and the second radio device.

Each of the different models of the direct discovery may require different actions of the respective radio device. By applying the technique for the first and second radio devices a consistent and undelayed discovery can be performed in at least some embodiments. The embodiments can avoid that the actions of the respective radio devices, in case a discovery procedure is triggered, are different and/or un-predictable. For example, the one of the at least two different models may be determined (e.g., selected) at the first radio device and/or the second radio device (e.g., a UE, optionally a remote UE or a relay UE) for consistent actions in the direct discovery.

By way of example, the one of the at least two different models may be determined according to one or more selection rules for the different models of the direct discovery. The technique may be implemented by applying the same one or more selection rules at each of the first and second radio devices.

The first radio device and the second radio device may be a remote radio device and a relay radio device, respectively, or vice versa. The proximity service may be used to relay a packet data unit (PDU) to or from a remote radio device (e.g., a remote UE or RM-UE) through a relay radio device (e.g., a relay UE or RL-UE). Alternatively or in addition, the remote radio device may be in a relayed radio communication with a RAN or a further remote radio device, wherein the relayed radio communication is relayed through the relay radio device by means of the proximity service.

For example, the relay radio device may be within radio coverage (briefly: coverage) of the RAN, i.e. radio-connected (briefly: connected) to a network node of the RAN such as an eNB or gNB, while the remote radio device may be out of coverage of the RAN. A layer 2 (L2) relay mechanism may comprise an adaptation layer, for example, according to the 3GPP document R2-2008266 “Summary of [AT111-e][605][Relay] L2 Relay Mechanism” by MediaTek Inc. for RAN2 #111-e.

The at least two different models of the direct discovery may comprise a model A and a model B of the direct discovery, e.g., as specified by 3GPP in LTE Releases 12 and 13, which may be (e.g., essentially) applied for the SL of LTE Release 17 or the SL of NR Release 17, particularly for a relayed radio communication between the remote radio device and the RAN (e.g., a UE-to-NW relay) and/or a relayed radio communication between the remote radio device and the further remote radio device (e.g., a UE-to-UE relay).

As to a second method aspect, a method of controlling a direct discovery between a first radio device and a second radio device according to a proximity service of a radio access technology (RAT) is provided. The proximity service comprises at least two different models of the direct discovery. The method comprises or initiates a step of transmitting a configuration message from the RAN to at least one of the first radio device and the second radio device, the configuration message being indicative of one of the at least two different models to be used in the direct discovery or a selection rule for selecting one of the at least two different models to be used in the direct discovery.

The second method aspect may further comprise any feature, or may comprise or initiate any step, disclosed in the context of the first method aspect or may comprise a feature or step corresponding thereto. For example, the first radio device may transmit a message, and the second may receive or expect reception of the corresponding message from the first radio device, or vice versa.

The first method aspect may be performed at or by one or more radio devices, e.g., any radio device configured for radio access to the RAN (e.g., for a downlink, DL, or an uplink, UL) and/or configured for proximity service with another radio device (e.g., for a sidelink, SL). Alternatively or in combination, the second method aspect may be performed at or by the RAN or a network node (e.g., by a base station) configured for providing radio access to the one or more radio devices (e.g., in a downlink or an uplink connection).

Any model for the direct discovery may also be referred to as a discovery model.

A channel for the proximity service (e.g., a physical channel of the SL) used for the data transmission and the radio reception, i.e., the channel between the transmitter and the receiver may comprise multiple subchannels or subcarriers (as a frequency domain). Alternatively, or in addition, the channel or SL may comprise one or more slots for a plurality of modulation symbols (as a time domain). Alternatively, or in addition, the channel or SL may comprise a directional transmission (also: beamforming transmission) at the transmitter, a directional reception (also: beamforming reception) at the receiver or a multiple-input multiple-output (MIMO) channel with two or more spatial streams (as a spatial domain).

The first radio device and the second radio device may be spaced apart. The first radio device and the second radio device may be in data communication or signal communication exclusively by means of a radio communication, e.g., the D2D communication or SL.

In a first embodiment, when the direct discovery (e.g., a discovery procedure) is triggered by at least one of the first and second radio devices (e.g., the remote radio device or the relay radio device), the respective radio device is configured to apply only one of the different models of the direct discovery. A selection rule for the one model may be pre-configured and/or signaled by the RAN, e.g., a network node (e.g., a gNB) of the RAN, or by a controlling radio device.

The one model or the selection rule may be signaled via at least one of the following signaling options, preferably prior to the triggering of the direct discovery and/or once for a plurality of discovery procedures. A first signaling option comprises radio resource control (RRC) signaling, e.g., Uu RRC or PC5-signaling. A second signaling option comprises a control element (CE) of a medium access control (MAC) layer. A third signaling option comprises L1 signaling (e.g., PDCCH, RACH, SCI etc.). A fourth signaling option comprises a control message (e.g., a control PDU) of a protocol layer. The protocol layer may be a Service Data Adaptation Protocol (SDAP, e.g. according to the 3GPP document TS 37.324, version 16.2.0), a Packet Data Convergence Protocol (PDCP, e.g. according to the 3GPP document TS 36.323, version 16.2.0), a Radio Link Control (RLC, e.g. according to the 3GPP document TS 36.322, version 16.0.0), or an adaptation layer.

Alternatively or in addition, the one model of the direct discovery may be pre-defined or the selection rule for selecting the one model of the direct discovery may be configured (e.g., pre-configured) by a Policy Charging Function (PCF) during a registration procedure (briefly: registration) of the respective radio device to a network (e.g., the RAN). For a PCF-based Service Authorization and Provisioning to respective radio device, the registration procedure may be defined in clause 4.2.2.2 of the 3GPP document TS 23.502, version 16.6.0. Access and Mobility management Function (AMF, e.g. according to the 3GPP document TS 33.512, version 16.3.0) may obtain the selection rule for the model from the PCF, e.g. via a service called Npcf_UEPolicyControl_Create, optionally according to a procedure called UE Policy Association Establishment defined in clause 4.16.11 of the 3GPP document TS 23.502, version 16.6.0.

In a second embodiment, when the direct discovery (e.g., a discovery procedure) is triggered by any one or each of the radio devices (e.g., a remote radio device or relay radio device), the respective radio device (i.e., the first or second radio device) may be configured to support all available discovery models, i.e., each of the at least two different models. The respective radio device may apply at least one of the following determination options to determine the one model of the at least two different models is to be used in the direct discovery.

According to a first determination option, e.g., upon trigger of a discovery event, the respective radio device starts to apply a discovery model for a configured time period. If there are no expected discovery messages (e.g., discovery announcement or discovery response message) received by the respective radio device, the respective radio device switches to a different discovery model.

According to a second determination option, each discovery model is mapped to specific discovery occasions (DOs). A discovery occasion (DO) may be an area or domain specified in time and/or frequency and/or space (or direction) that is available for the transmission or reception of a discovery message. This term is just an example. Similar terms are interchangeable applicable. Upon trigger of a discovery event, the respective radio device does nothing (e.g., as far as the discovery is concerned) until a subsequent DO is available. Then, the respective radio device determines the discovery model based on the mapping relation between the DO and the discovery model.

The respective radio device may then further initiate a corresponding discovery procedure according to the determined model.

If the discovery procedure cannot be completed successfully until the next (e.g. subsequent) DO is available, the respective radio device may change to a different discovery model and initiates a further discovery procedure.

In any aspect, the technique may be applied in the context of 3GPP New Radio (NR). Unlike a SL according to 3GPP LTE, a SL according to 3GPP NR can provide a wide range of QoS levels. Therefore, at least some embodiments of the technique can ensure that SL is established in fulfilment of the QoS of the traffic.

The technique may be implemented in accordance with a 3GPP specification, e.g., for 3GPP release 17. The technique may be implemented for 3GPP LTE or 3GPP NR according to a modification of the 3GPP document TS 23.303, version 16.0.0 or for 3GPP NR according to a modification of the 3GPP document TS 33.303, version 16.0.0.

In any radio access technology (RAT), the technique may be implemented by means of selection rules for selecting a discovery model of a direct discovery. The direct discovery, and optionally a SL resulting from the direct discovery, may be implemented using a proximity service (ProSe), e.g. according to a specification of 3GPP or Wi-Fi Alliance.

Herein, any radio device may be a user equipment (UE), e.g., according to a 3GPP specification. The relay radio device may also be referred to as a relay UE (or briefly: relay). Alternatively or in addition, the remote radio device may also be referred to as a remote UE. Alternatively or in addition, the further remote radio device may also be referred to as a further UE.

The relay radio device and the RAN may be wirelessly connected in an uplink (UL) and/or a downlink (DL) through a Uu interface. Alternatively or in addition, the SL may enable a direct radio communication between proximal radio devices, e.g., the remote radio device and the relay radio device, optionally using a PC5 interface. Services provided using the SL or the PC5 interface may be referred to as proximity services (ProSe). Any radio device (e.g., the remote radio device and/or the relay radio device and/or the further radio device) supporting a SL may be referred to as ProSe-enabled radio device.

The relay radio device may also be referred to as ProSe UE-to-Network Relay.

Whenever referring to the RAN, the RAN may be implemented by one or more network nodes (e.g., base stations or cells).

In any aspect, any of the radio devices and/or network nodes may form, or may be part of, a radio network, e.g., according to the Third Generation Partnership Project (3GPP) or according to the standard family IEEE 802.11 (Wi-Fi). The radio network may be a radio access network (RAN) comprising one or more base stations (e.g., network nodes). Alternatively, or in addition, the radio network may be a vehicular, ad hoc and/or mesh network. The first method aspect may be performed by one or more embodiments of the radio devices in the radio network. The second method aspect may be performed by one or more embodiments of the base stations in the radio network.

Any of the radio devices may be a mobile or wireless device, e.g., a 3GPP user equipment (UE) or a Wi-Fi station (STA). The radio device may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Any of the radio devices may be wirelessly connected or connectable (e.g., according to a radio resource control, RRC, state or active mode) with any of the base stations. Herein, the base station may encompass any station that is configured to provide radio access to any of the radio devices. The base stations may also be referred to as transmission and reception point (TRP), radio access node or access point (AP). The base station or one of the radio devices functioning as a gateway (e.g., between the radio network and the RAN and/or the Internet) may provide a data link to a host computer providing the data. Examples for the base stations may include a 3G base station or Node B, 4G base station or eNodeB, a 5G base station or gNodeB, a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer, a Radio Resource Control (RRC) layer and/or an adaptation layer of a protocol stack for the radio communication.

As to another aspect, a computer program product is provided. The computer program product comprises program code portions for performing the steps of any one or both of the method aspects disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

First device aspects may be provided or implemented alone or in combination with any one of the claims 42, 44, 46, and/or 54. Furthermore, any of the first device aspects may be provided or implemented alone or in combination with any one of the embodiments described hereinbelow.

As to a first device aspect, a radio device for performing direct discovery between a first radio device and a second radio device according to a proximity service of a radio access technology (RAT) is provided, wherein the proximity service comprises at least two different models of the direct discovery. The radio device is configured to perform the direct discovery according to one of the at least two different models.

The radio device (e.g., according to the first device aspect) may be configured to perform the steps of any one of embodiments according to the first method aspects.

Second device aspects may be provided or implemented alone or in combination with any one of the claims 48, 50, 52 and 54. Furthermore, each of the second device aspects may be provided or implemented alone or in combination with any one of the embodiments described hereinbelow.

The device may be configured to perform any one of the steps of the second method aspect.

As to a second device aspect, a network node for controlling direct discovery between a first radio device and a second radio device according to a proximity service of a radio access technology (RAT) is provided, wherein the proximity service comprises at least two different models of the direct discovery. The network node is configured to transmit a configuration message from the RAN to at least one of the first radio device and the second radio device, the configuration message being indicative of one of the at least two different models to be used in the direct discovery or a selection rule for selecting one of the at least two different models to be used in the direct discovery.

The network node (e.g., according to the second device aspect) may further configured to perform the steps of any one of embodiment according to the second method aspects.

As to a still further aspect a communication system including a host computer is provided. The host computer may comprise a processing circuitry configured to provide user data, e.g., depending on the location of the UE determined in the locating step. The host computer may further comprise a communication interface configured to forward user data to a cellular network for transmission to a user equipment (UE), wherein the UE comprises a radio interface and processing circuitry, a processing circuitry of the cellular network being configured to execute any one of the steps of the first and/or second method aspect.

The communication system may further include the UE. Alternatively, or in addition, the cellular network may further include one or more base stations and/or gateways configured to communicate with the UE and/or to provide a data link between the UE and the host computer using the first method aspect and/or the second method aspect.

The processing circuitry of the host computer may be configured to execute a host application, thereby providing the user data and/or any host computer functionality described herein. Alternatively, or in addition, the processing circuitry of the UE may be configured to execute a client application associated with the host application.

Any one of the devices, the UE, the network node, the base station, the system or any node or station for embodying the technique may further include any feature disclosed in the context of the method aspects, and vice versa. Particularly, any one of the units and modules, or a dedicated unit or module, may be configured to perform or initiate one or more of the steps of the method aspect.

### BRIEF DESCRIPTION OF THE DRAWINGS

Further details of embodiments of the technique are described with reference to the enclosed drawings, wherein:

FIG. 1A shows a schematic block diagram of an embodiment of device for performing direct discovery between a first radio device and a second radio device according to a proximity service;

FIG. 1B shows a schematic block diagram of an embodiment of device for controlling direct discovery between a first radio device and a second radio device according to a proximity service;

FIG. 2A shows an example flowchart for a method of performing direct discovery between a first radio device and a second radio device according to a proximity service, which method may be implementable by the device of FIG. 1A;

FIG. 2B shows an example flowchart for a method of controlling direct discovery between a first radio device and a second radio device according to a proximity service, which method may be implementable by the device of FIG. 1B;

FIG. 3 shows an example deployment scenario for a relayed radio communication;

FIG. 4 schematically shows a physical resource grid of a 3GPP NR implementation;

FIG. 5 shows a schematic signaling diagram resulting from embodiments of the devices of FIGS. 1A and 18 performing implementations of the methods of 2A and 2B;

FIG. 6 schematically illustrates discovery occasions in the time domain and in the frequency domain;

FIG. 7 shows an example schematic block diagram of a remote radio device embodying the device of FIG. 1A;

FIG. 8 shows an example schematic block diagram of a relay radio device embodying the device of FIG. 1A;

FIG. 9 shows an example schematic block diagram of a network node embodying the device of FIG. 1B;

FIG. 10 schematically illustrates an example telecommunication network connected via an intermediate network to a host computer;

FIG. 11 shows a generalized block diagram of a host computer communicating via a base station or radio device functioning as a gateway with a user equipment over a partially wireless connection; and

FIGS. 12 and 13 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including 3GPP LTE (e.g., LTE-Advanced or a related radio access technique such as MulteFire), in a Wireless Local Area Network (WLAN) according to the standard family IEEE 802.11, for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

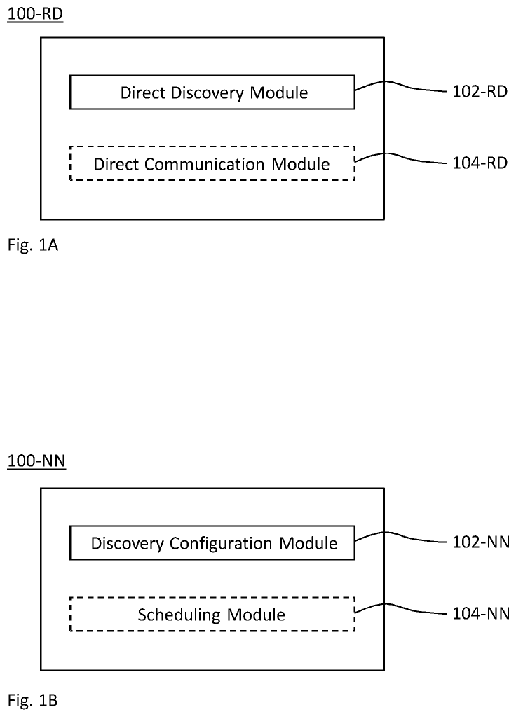

FIG. 1A schematically illustrates an example block diagram of a device according to the first device aspect. The device is generically referred to by reference sign 100-RD.

The device 100-RD comprises a Direct Discovery Module 102-RD that performs the direct discovery according to one of the at least two different models.

Optionally, the device 100-RD comprises a Direct Communication Module 104-RD that performs a direct communication between the first radio device and the second radio device according to the proximity service responsive to the match.

Any of the units of the device 100-RD may be implemented by modules configured to provide the corresponding functionality.

The device 100-RD may also be referred to as, or may be embodied by, the first radio device (e.g., first UE or labelled 100-RD1 or 100-RD2) and/or the second radio device (e.g., second UE or labelled 100-RD2 or 100-RD1). The device 100-RD and the RAN (e.g., the network node, particularly a base station of the RAN) may in a radio communication (preferably D2D communication or Uu).

FIG. 1B schematically illustrates an example block diagram of a device according to the second device aspect. The device is generically referred to by reference sign 100-NN.

The device 100-NN comprises a Discovery Configuration Module 102-NN that transmits a configuration message from the RAN to at least one of the first radio device and the second radio device, the configuration message being indicative of one of the at least two different models to be used in the direct discovery or a selection rule for selecting one of the at least two different models to be used in the direct discovery.

Optionally, the device 100-NN comprises Scheduling Module 104-NN that transmits a scheduling message from the RAN to at least one of the first radio device and the second radio device, the scheduling message being indicative of radio resources to be used in at least one of the direct discovery or a direct communication resulting from a match determined in the direct discovery.

Any of the units of the device 100-NN may be implemented by modules configured to provide the corresponding functionality.

The device 100-NN may also be referred to as, or may be embodied by, the RAN or the network node (e.g., a base station) of the RAN or of the CN.

The technique may be applied to uplink (UL), downlink (DL) or direct communications between radio devices, e.g., device-to-device (D2D) communications or sidelink (SL) communications.

The device 100-RD (e.g., the first and/or second radio device) and the device 100-NN (e.g., the network node) may be a radio device and/or a network node (e.g., a base station). Herein, any radio device may be a mobile or portable station and/or any radio device wirelessly connectable to the network node (e.g., a base station) and/or the RAN, or to another radio device. A radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP sidelink connection. Furthermore, any base station may be a station providing radio access, may be part of a radio access network (RAN) and/or may be a node connected to the RAN for controlling radio access. Further a base station may be an access point, for example a Wi-Fi access point.

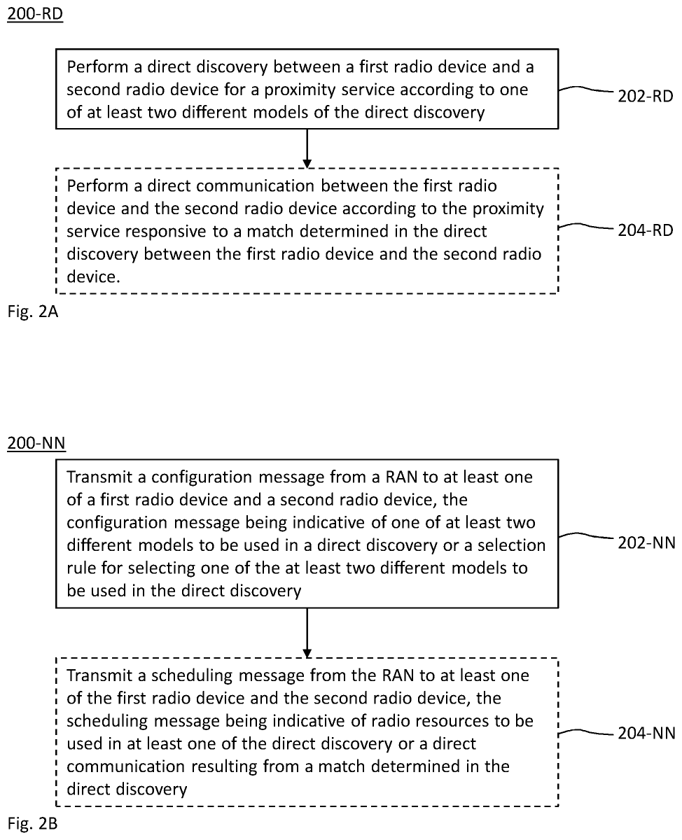

FIG. 2A shows an example flowchart for a method 200-RD according to the first method aspect.

The method 200-RD may be performed by the device 100-RD. For example, the units 102-RD and 104-RD may perform the steps 202-RD and 204-RD, respectively.

The first method aspect relates to a method 200-RD of performing direct discovery between a first radio device and a second radio device according to a proximity service of a radio access technology (RAT). The proximity service comprises at least two different models of the direct discovery. The method comprises or initiates a step 202-RD of performing the direct discovery according to one of the at least two different models.

The proximity service may also be referred to as a proximity-based service (ProSe). The first radio device and the second radio device may be ProSe-enabled radio devices, e.g., user equipments (UEs) according to 3GPP or stations according to the Wi-Fi Alliance.

The proximity service may comprise the at least two different models as alternatives for performing the direct discovery.

The at least one or each of the first radio device and the second radio device (e.g., according to the first method aspect) may be configured to perform the direct discovery using exclusively the one of the at least two different models.

The one of the at least two different models (e.g., according to the first method aspect) may be pre-configured in at least one or each of the first radio device and the second radio device.

The method (e.g., according to the first method aspect) may further comprise receiving, at the first radio device, a configuration message. The configuration message may be indicative of the one of the at least two different models to be used for the performing of the direct discovery. The configuration message may be further indicative of a selection rule. Alternatively or in addition, the method (e.g., according to the first method aspect) may further comprises selecting, at the first radio device, the one of the at least two different models to be used for the performing of the direct discovery according to the selection rule.

The configuration message (e.g., according to the first method aspect) may be received at the first radio device from the second radio device.

The at least one of the first radio device and the second radio device (e.g., according to the first method aspect) may be in a radio-connected state with a radio access network (RAN).

Each of the first radio device and the second radio device may be configured to establish a radio connection with the RAN.

The configuration message (e.g., according to the first method aspect) may be received, from the RAN, at the first radio device and/or at the second radio device.

The configuration message (e.g., according to the first method aspect) may be received, at the first radio device and/or at the second radio device, from a Policy Control Function (PCF) of the RAN or an Access and Mobility Management Function (AMF) of the RAN. The configuration message (e.g., according to the first method aspect) may be received at the first radio device upon registering the first radio device at the RAN.

The first radio device (e.g., according to the first method aspect) may be out of coverage of the RAN. The configuration message (e.g., according to the first method aspect) may be received at the first radio device as relayed through the second radio device from the RAN.

The configuration message (e.g., according to the first method aspect) may comprise at least one of radio resource control (RRC) signaling; a medium access control (MAC) control element (CE); a control signal on a physical control channel; a control packet data unit (PDU) of a packet data convergence protocol (PDCP); a control PDU of a radio link control (RLC); a control PDU of a Service Data Adaptation Protocol (SDAP) defining or implying a quality of service (QoS) flow for the proximity service; and a control PDU of an adaptation layer relaying a radio communication through the first radio device or the second radio device using the proximity service.

The performing of the direct discovery (e.g., according to the first method aspect) may be triggered by at least one of the first radio device and the second radio device, optionally by an application layer of the first radio device or the second radio device.

The method (e.g., according to the first method aspect) may be performed by at least one or each of the first radio device and the second radio device.

A result of the direct discovery may comprise a match between the first radio device and the second radio device according to the proximity service. The method (e.g., according to the first method aspect) may further comprises a step 204-RD of performing a direct communication between the first radio device and the second radio device according to the proximity service responsive to the match.

The direct communication may be a direct radio communication between the first radio device and the second radio device using the RAT for the proximity service. Performing the direct discovery may comprise establishing the direct communication by radio resource control (RRC) signaling.

The direct communication according to the proximity service (e.g., a ProSe Communication) may be a communication between at least the first radio device and the second radio device in proximity by means of a ProSe communication path, e.g., a PC5 interface according to the 3GPP document TS 23.303, version 16.0.0. Unless explicitly stated otherwise, the term “ProSe Communication” may refer to at least one or each of the following: a ProSe E-UTRA Communication between only the first and second radio devices as two ProSe-enabled UEs; a ProSe Group Communication or a ProSe Broadcast Communication among Public Safety ProSe-enabled UEs comprising the first and second radio device; and a ProSe-assisted WLAN direct communication, e.g., between the first and second radio devices as Wi-Fi stations.

The performing of the at least one of the direct discovery and the direct communication (e.g., according to the first method aspect) may comprise transmitting a message directly from the first radio device to the second radio device using the RAT. Alternatively or in addition, the performing of the at least one of the direct discovery and the direct communication (e.g., according to the first method aspect) may comprise receiving a message directly from the first radio device at the second radio device using the RAT.

At least one of the direct discovery and the direct communication may uses a device-to-device (D2D) radio communication. Transmitting the message may comprise radio-transmitting the message. Receiving the message may comprise radio-receiving the message. The message may be transmitted or received on a radio channel between the first radio device and the second radio device. The radio channel may also be referred to as sidelink or a ProSe communication path.

The first radio device (e.g., according to the first method aspect) may be an announcing radio device according to the proximity service and the second radio device (e.g., according to the first method aspect) may be a monitoring radio device according to the proximity service, if the one of the different models is a first model. The first radio device (e.g., according to the first method aspect) may be a discoverer radio device according to the proximity service and the second radio device may be a discoveree radio device according to the proximity service, if the one of the different models is a second model.

The performing of the direct discovery (e.g., according to the first method aspect) may comprise transmitting a discovery message directly from the first radio device to the second radio device according to the proximity service. The performing of the discovery (e.g., according to the first method aspect) may comprise receiving a discovery message directly from the first radio device at the second radio device according to the proximity service.

A first model of the different models may be a model A according to clause 5.3.1.2 of the 3GPP document TS 23.303, version 16.0.0.

The discovery message may be an announcement according to the first model.

The transmitting of the discovery message (e.g., according to the first method aspect) may comprise unicasting and/or group casting an announcement according to a first model of the different models, and/or wherein an announcement is transmitted periodically according to the first model of the different models.

The receiving of the discovery message (e.g., according to the first method aspect) may comprise monitoring a channel of the proximity service for an announcement according to a first model of the different models.

The announcement (e.g., according to the first method aspect) may be indicative of information provided or retrievable by the first radio device.

A second model of the different models may be a model B according to clause 5.3.1.2 of the 3GPP document TS 23.303, version 16.0.0.

The transmitting of the discovery message (e.g., according to the first method aspect) may comprise broadcasting or group casting the discovery message according to a second model of the different models.

The receiving of the discovery message (e.g., according to the first method aspect) may comprise monitoring a channel of the proximity service for a query code of the proximity service according to the second model.

The discovery message (e.g., according to the first method aspect) may be indicative of information required by the first radio device and/or requested from the second radio device.

The performing of the direct discovery (e.g., according to the first method aspect) may further comprise receiving a response message in response to the transmitted discovery message according to the second model. Alternatively or in addition, the performing of the direct discovery (e.g., according to the first method aspect) may further comprise transmitting a response message in response to the received discovery message according to the second model. The response message may be indicative of a response code of the proximity service according to the second model.

The first radio device (e.g., according to the first method aspect) may be a remote radio device in a relayed radio communication with a RAN or a further remote radio device. The relayed radio communication (e.g., according to the first method aspect) may be relayed through the second radio device as a relay radio device of the relayed radio communication. The second radio device (e.g., according to the first method aspect) may be a remote radio device in a relayed radio communication with a RAN or a further remote radio device. The relayed radio communication (e.g., according to the first method aspect) may be relayed through the first radio device as a relay radio device of the relayed radio communication.

The at least one or each of the first radio device and the second radio device (e.g., according to the first method aspect) may be configured to perform the direct discovery according to each of the different models

The performing of the direct discovery (e.g., according to the first method aspect) may comprise performing the direct discovery according to the one of the at least two different models for a configured time period. The method (e.g., according to the first method aspect) may further comprise performing the direct discovery according to another one of the at least two different models if a control message expected according to the one model is outstanding upon expiry of the configured time period.

The other one model may be different from the one model. The one model of the different models may be the first model, and the other one model of the different models may be the second model, or vice versa.

The expected control massage outstanding at the second radio device may be the discovery message, e.g., the announcement if the first radio device is the announcing radio device. Alternatively or in addition, the expected control massage outstanding at the first radio device may be the response message, e.g., the discovery response message if the first radio device is the discoverer radio device.

The method (e.g., according to the first method aspect), wherein a physical channel between the first radio device and the second radio device for the proximity service may comprise a plurality of discovery occasions (DOs), each of the DOs being associated with one of the different models. The performing of the direct discovery in a DO out of the plurality of DOs uses the model associated with the DO as the one of the different models.

The association of a model out of the at least two different models with any one of the plurality of DOs may also be referred to as a mapping. For example, each of the at least two different models may be mapped to (e.g., a respectively disjoint subset of) the plurality of DOs.

The plurality of DOs (e.g., according to the first method aspect) may be distinct in terms of at least one of time, frequency and spatial stream.

The DO out of the plurality of DOs (e.g., according to the first method aspect) may be the first DO subsequent to an event triggering the direct discovery.

The performing of the direct discovery (e.g., according to the first method aspect) may be resumed or restarted in a second DO subsequent to the first DO using the model associated with the second DO, if a control message expected according to the one model is outstanding upon expiry of the first DO.

The performing of the direct discovery (e.g., according to the first method aspect) may further comprise while the direct discovery is performed according to the one model, performing or initiating a further direct discovery according to another model out of the at least two different models. The direct discovery and the further direct discovery may be performed partly overlapping in time.

The performing of the direct discovery (e.g., according to the first method aspect) may further comprise performing or initiating the direct discovery according to the one model and performing or initiating in parallel a further direct discovery according to another model out of the at least two different models. The direct discovery and the further direct discovery may be fully overlap in time.

The one model for the step of performing the direct discovery (e.g., according to the first method aspect) may be selected out of the at least two different models based on a service and/or an application which triggered the direct discovery, optionally depending on a latency requirement of the service or the application. The different models may be associated with different latency requirements.

The one model for the step of performing the direct discovery (e.g., according to the first method aspect) may be selected out of the at least two different models based on a purpose of the direct discovery. The different models may be associated with different purposes, optionally depending on the purpose of the direct discover, comprising at least one of finding a service or application in proximity provided by the first radio device to the second radio device or vice versa, establishing a data communication between the first and second radio devices, and establishing a relayed radio communication. The first radio device may act as the remote radio device, and the second radio device may act as the relay radio device, or vice versa.

The one model for the step of performing the direct discovery (e.g., according to the first method aspect) may be selected out of the at least two different models depending on a state of a power supply or a range of remaining energy of the respective radio device performing the direct discovery. The different models may be associated with different states of the power supply or different ranges of the remaining energy.

The one model for the step of performing the direct discovery (e.g., according to the first method aspect) may be selected out of the at least two different models depending on an occupancy of a channel of the proximity service and/or a load of radio devices in proximity. The different models may be associated with different states of the occupancy of the channel and/or different states of the load.

The one model for the step of performing the direct discovery (e.g., according to the first method aspect) may be selected out of the at least two different models depending on a frequency of a channel of the proximity service. The different models may be associated with different frequencies of the channel.

FIG. 2B shows an example flowchart for a method 200-NN according to the second method aspect.

The method 200-NN may be performed by the device 100-NN. For example, the units 102-NN and 104-RD may perform the steps 202-NN and 204-NN, respectively.

The second method aspect relates to a method 200-NN of controlling direct discovery between a first radio device and a second radio device according to a proximity service of a radio access technology (RAT). The proximity service comprises at least two different models of the direct discovery. The method comprises or initiates a step 202-NN of transmitting a configuration message from the RAN to at least one of the first radio device and the second radio device, the configuration message being indicative of one of the at least two different models to be used in the direct discovery or a selection rule for selecting one of the at least two different models to be used in the direct discovery.

The method (e.g., according to the second method aspect) may further comprise or initiate a step 204-NN of transmitting a scheduling message from the RAN to at least one of the first radio device and the second radio device. The scheduling message may be indicative of radio resources to be used in at least one of the direct discovery or a direct communication resulting from a match determined in the direct discovery.

The method (e.g., according to the second method aspect) may further comprise the features or steps of any one of the embodiments according to the first method aspect, or features or steps corresponding thereto.

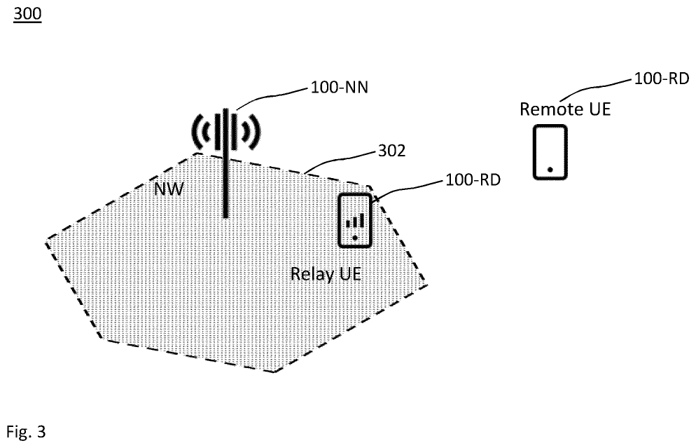

FIG. 3 shows an example deployment scenario for a relayed radio communication 300. The deployment scenario comprises a network node 100-NN of a RAN with coverage area 302. A RL radio device 100-RL is in the coverage area 302 of the network node 100-NN. ARM radio device 100-RM is outside of the coverage area 302 of the network node 100-NN, but in proximity to the RL radio deice 100-RL. By being in the proximity, the RM radio device 100-RM and the RL radio device 100-RL may be in a D2D communication.

Any embodiment may be implemented using a frame structure for the relayed radio communication and/or the D2D communication, e.g., according to 3GPP NR.

Similar to LTE, NR uses OFDM (Orthogonal Frequency Division Multiplexing) in the DL (e.g., from a network node, gNB, eNB, or base station, to a user equipment or UE).

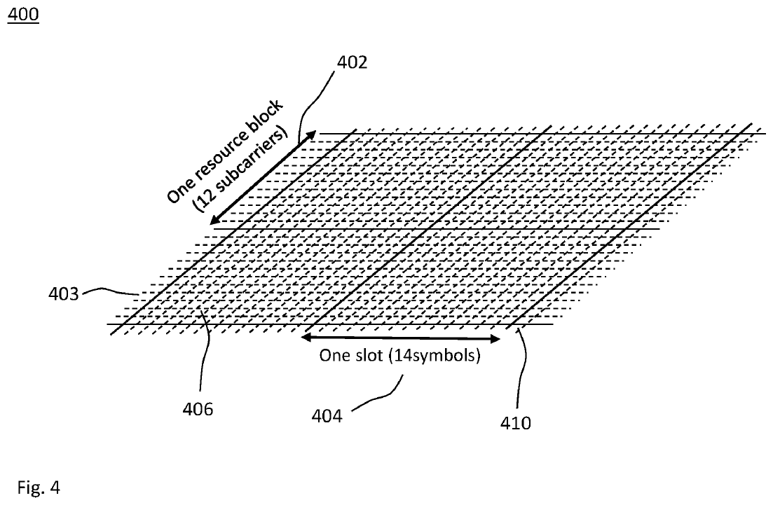

FIG. 4 schematically illustrates a physical resource grid 400 for a 3GPP NR implementation of the technique.

The basic NR physical resource over an antenna port can be seen as a time-frequency grid as illustrated in FIG. 4, where a resource block (RB) 402 in a 14-symbol slot 404 is shown. A RB 402 corresponds to 12 contiguous subcarriers 403 in the frequency domain. RBs 402 are numbered in the frequency domain, starting with 0 from one end of the system bandwidth. Each resource element (RE) 406 corresponds to one OFDM subcarrier during one OFDM symbol 410 interval. A slot 404 comprises 14 OFDM symbols 410.

Different subcarrier spacing values are supported in NR. The supported subcarrier spacing values (also referred to as different numerologies) are given by Δf=(15×2^{μ}) kHz, wherein the exponent μ∈(0, 1, 2, 3, 4)·Δf=15 kHz is the basic (or reference) subcarrier spacing that is also used in LTE.

In the time domain, DL and UL transmissions in NR are organized into equally-sized subframes of 1 ms each similar to LTE. A subframe is further divided into multiple slots 404 of equal duration. The slot length for subcarrier spacing Δf=(15×2\hat{ }μ) kHz is (½)\hat{ }μ ms. There is only one slot 404 per subframe for Δf=15 kHz, and a slot 404 consists of 14 OFDM symbols 410.

DL transmissions are dynamically scheduled, e.g., in each slot the gNB transmits DL control information (DCI) about which radio device (e.g., UE) data is to be transmitted to and which RBs in the current DL slot the data is transmitted on. This control information is conventionally transmitted in the first one or two OFDM symbols in each slot in NR. The control information is carried on the Physical Control Channel (PDCCH), and data is carried on the Physical Downlink Shared Channel (PDSCH). A radio device (e.g., a UE) first detects and decodes PDCCH and, if a PDCCH is decoded successfully, it (e.g., the UE) then decodes the corresponding PDSCH based on the DL assignment provided by decoded control information in the PDCCH.

In addition to PDCCH and PDSCH, there are also other channels and reference signals transmitted in the downlink, including synchronization signal blocks (SSBs), channel state information reference signals (CSI-RS), etc.

UL data transmissions, carried on Physical Uplink Shared Channel (PUSCH), can also be dynamically scheduled by the gNB by transmitting a DCI. The DCI (which is transmitted in the DL region) indicates a scheduling time offset so that the PUSCH is transmitted in a slot in the UL region.

Any embodiment may be implemented using a sidelink (SL) in NR for the D2D communication.

SL transmissions over NR are specified for Rel. 16. These are enhancements of the ProSe (PROximity-based SErvices) specified for LTE. Four new enhancements are particularly introduced to NR sidelink transmissions as follows:
Support for unicast and groupcast transmissions are added in NR SL. For unicast and groupcast, the physical sidelink feedback channel (PSFCH) is introduced for a receiver radio device (e.g., a receiver UE) to reply the decoding status to a transmitter radio device (e.g., a transmitter UE).
Grant-free transmissions, which are adopted in NR UL transmissions, are also provided in NR SL transmissions, to improve the latency performance.
To alleviate resource collisions among different SL transmissions launched by different radio devices (e.g., different UEs), it enhances channel sensing and resource selection procedures, which also lead to a new design of PSCCH.
To achieve a high connection density, congestion control and thus the quality of service (QoS) management is supported in NR SL transmissions.

To enable the above enhancements, new physical channels and reference signals (RSs) are introduced in NR (available in LTE before):
PSSCH (Physical Sidelink Shared Channel, SL version of PDSCH): The PSSCH is transmitted by a SL transmitter radio device (e.g., SL transmitter UE), which conveys SL transmission data, system information blocks (SIBs) for radio resource control (RRC) configuration, and a part of the sidelink control information (SCI).
PSFCH (Physical Sidelink, SL version of PUCCH): The PSFCH is transmitted by a SL receiver radio device (e.g., a SL receiver UE) for unicast and groupcast, which conveys 1 bit information over 1 RB for the HARQ acknowledgement (ACK) and the negative ACK (NACK). In addition, channel state information (CSI) is carried in the medium access control (MAC) control element (CE) over the PSSCH instead of the PSFCH.
PSCCH (Physical Sidelink Common Control Channel, SL version of PDCCH): When the traffic to be sent to a receiver radio device (e.g., a receiver UE) arrives at a transmitter radio device (e.g., a transmitter UE), a transmitter radio device (e.g., transmitter UE) should first send the PSCCH, which conveys a part of SCI (Sidelink Control information, SL version of DCI) to be decoded by any radio device (e.g., UE) for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar DL transmissions in NR, in SL transmissions, primary and secondary synchronization signals (called S-PSS and S-SSS, respectively) are supported. Through detecting the S-PSS and S-SSS, a radio device (e.g., a UE) is able to identify the SL synchronization identity (SSID) from the radio device (e.g., UE) sending the S-PSS/S-SSS. Through detecting the S-PSS/S-SSS, a radio device (e.g., UE) is therefore able to know the characteristics of the radio device (e.g., UE) transmitting the S-PSS/S-SSS. A series of processes of acquiring timing and frequency synchronization together with SSIDs of radio devices (e.g., UEs) is called initial cell search. Note that the radio device (e.g., UE) sending the S-PSS/S-SSS may not be necessarily involved in SL transmissions, and a node (e.g., a UE and/or eNB and/or gNB) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured BWP. The PSBCH conveys information related to synchronization, such as the direct frame number (DFN), indication of the slot and symbol level time resources for sidelink transmissions, in-coverage indicator, etc. The SSB is transmitted periodically at every 160 ms.
DMRS, phase tracking reference signal (PT-RS), channel state information reference signal (CSI-RS): These physical reference signals supported by NR DL/UL transmissions are also adopted by SL transmissions. Similarly, the PT-RS is only applicable for FR2 transmission.

Another new feature is the two-stage SL control information (SCI). This a version of the DCI for SL. Unlike the DCI, only part (first stage) of the SCI is sent on the PSCCH. This part is used for channel sensing purposes (including the reserved time-frequency resources for transmissions, demodulation reference signal (DMRS) pattern and antenna port, etc.) and can be read by all radio devices (e.g., UEs) while the remaining (second stage) scheduling and control information such as a 8-bits source identity (ID) and a 16-bits destination ID, NDI, RV and HARQ process ID is sent on the PSSCH to be decoded by the receiver radio device (e.g., UE).

Similar as for PRoSE in LTE, NR SL transmissions have the following two modes of resource allocations:
Mode 1: SL resources are scheduled by a network node (e.g., gNB).
Mode 2: The radio device (e.g., UE) autonomously selects SL resources from a configured or preconfigured SL resource pool(s) based on the channel sensing mechanism.

For the in-coverage radio device (e.g., UE), a network node (e.g., gNB) can be configured to adopt Mode 1 or Mode 2. For the out-of-coverage radio device (e.g., UE), only Mode 2 can be adopted.

As in LTE, scheduling over the SL in NR is done in different ways for Mode 1 and Mode 2.

Mode 1 supports the following two kinds of grants, namely dynamic grants and configured grants.

Dynamic grant: When the traffic to be sent over SL arrives at a transmitter radio device (e.g., UE), this radio device (e.g., UE) should launch the four-message exchange procedure to request SL resources from a network node, e.g. gNB (SR on UL, grant, BSR on UL, grant for data on SL sent to the radio device, e.g., UE). During the resource request procedure, a network node (e.g., gNB) may allocate a SL radio network temporary identifier (SL-RNTI) to the transmitter radio device (e.g., UE). If this SL resource request is granted by a network node (e.g., gNB), then a network node (e.g., gNB) indicates the resource allocation for the PSCCH and the PSSCH in the downlink control information (DCI) conveyed by PDCCH with cyclic redundancy check (CRC) scrambled with the SL-RNTI. When a transmitter radio device (e.g., UE) receives such a DCI, a transmitter radio device (e.g., UE) can obtain the grant only if the scrambled CRC of DCI can be successfully solved by the assigned SL-RNTI. A transmitter radio device (e.g., UE) then indicates the time-frequency resources and the transmission scheme of the allocated PSSCH in the PSCCH, and launches the PSCCH and the PSSCH on the allocated resources for SL transmissions. When a grant is obtained from a network node (e.g., gNB), a transmitter radio device (e.g., UE) can only transmit a single transport block (TB). As a result, this kind of grant is suitable for traffic with a loose latency requirement.

Configured grant: For the traffic with a strict latency requirement, performing the four-message exchange procedure to request SL resources may induce unacceptable latency. In this case, prior to the traffic arrival, a transmitter radio device (e.g., UE) may perform the four-message exchange procedure and request a set of resources. If a grant can be obtained from a network node (e.g., gNB), then the requested resources are reserved in a periodic manner. Upon traffic arriving at a transmitter radio device (e.g., UE), this radio device (e.g., UE) can launch the PSCCH and the PSSCH on the upcoming resource occasion. This kind of grant is also known as grant-free transmissions.

In both dynamic grant and configured grant, a SL receiver radio device (e.g., UE) cannot receive the DCI since it is addressed to the transmitter radio device (e.g., UE), and therefore a receiver radio device (e.g., UE) should perform blind decoding to identify the presence of PSCCH and find the resources for the PSSCH through the SCI.

When a transmitter radio device (e.g., UE) launches the PSCCH, CRC is also inserted in the SCI without any scrambling.

In the Mode 2 resource allocation, when traffic arrives at a transmitter radio device (e.g., UE), this transmitter radio device (e.g., UE) should autonomously select resources for the PSCCH and the PSSCH. To further minimize the latency of the feedback HARQ ACK/NACK transmissions and subsequently retransmissions, a transmitter radio device (e.g., UE) may also reserve resources for PSCCH/PSSCH for retransmissions. To further enhance the probability of successful TB decoding at one shot and thus suppress the probability to perform retransmissions, a transmitter radio device (e.g., UE) may repeat the TB transmission along with the initial TB transmission. This mechanism is also known as blind retransmission. As a result, when traffic arrives at a transmitter radio device (e.g., UE), then this transmitter radio device (e.g., UE) should select resources for the following transmissions:
1) The PSSCH associated with the PSCCH for initial transmission and blind retransmissions.
2) The PSSCH associated with the PSCCH for retransmissions.

Since each transmitter radio device (e.g., UE) in SL transmissions should autonomously select resources for above transmissions, how to prevent different transmitter radio devices (e.g., UEs) from selecting the same resources turns out to be a critical issue in Mode 2. A particular resource selection procedure is therefore imposed to Mode 2 based on channel sensing. The channel sensing algorithm involves measuring reference signal received power (RSRP) on different subchannels and requires knowledge of the different radio devices (e.g., UEs) power levels of DMRS on the PSSCH or the DMRS on the PSCCH depending on the configuration. This information is known only after receiver SCI launched by (all) other radio devices (e.g., UEs). The sensing and selection algorithm is rather complex.

Herein, the expressions D2D communication and direct communication may be used interchangeably. Furthermore, the direct discover (briefly: discovery) may also be referred to as a discovery procedure (also: D2D discovery procedure) or discovery mechanism. In any embodiment, the D2D communication may be based on or initiated by a discovery procedure.

There are D2D discovery procedures for detection of services and applications offered by other radio devices 100-RD (e.g., UEs) in close proximity. This is part of LTE Release 12 and Release 13.

In an embodiment, which is combinable with any other embodiment disclosed herein, the discovery procedure has two models (i.e., the proximity service comprises two models). A model A is based on open announcements (e.g., broadcasts) as discovery messages, and a model B, which comprises at least one of a request and a response as discovery message or discovery response.

The different models (e.g., the models A and B) may also be referred to as modes.

For concreteness and without, any radio device (e.g., the first and/or the second radio device) may be referred to as a user equipment (UE).

The discovery mechanism is controlled by the application layer (e.g., ProSe). In LTE, the discovery message is sent on the Physical Sidelink Discovery Channel (PSDCH) which is not available in NR. Also, there is a specific resource pool for announcement and monitoring of discovery messages.

In any RAT, the discovery procedure can be used to detect radio devices (e.g., UEs) supporting certain services or applications before initiating direct communication.

Any embodiment may be implemented in accordance with or in extension of at least one of the following 3GPP documents: TS 38.331, version 16.2.0; TS 38.300, version 16.3.0; TS 36.331, version 16.2.1; TS 36.300, version 16.3.0; and TS 23.303, version 16.0.0.

Any of the embodiments disclosed herein may perform or control the direct discovery according to a ProSe Direct Discovery specified by 3GPP.

As described in clause 6.1 of the 3GPP document TR 23.752, version 0.5.0 (“Study on system enhancement for Proximity based Services (ProSe) in the 5G System (5G5)”), the discovery procedure for NR Release 17 may be based on a 5G Core Network (5GC) architecture, including authorization and provision, announcing and monitoring procedures, and protocol for discovery as detailed in clause 6.1.2 of the 3GPP document TR 23.752, version 0.5.0.

In LTE (e.g., in an Evolved Packet System, EPS), there are two types of ProSe Direct Discovery: open and restricted. Open discovery is the case, in which there is no explicit permission that is needed from the UE being discovered, whereas restricted discovery only takes place with explicit permission from the UE that is being discovered. In this solution, only restricted type is proposed.

Two models for ProSe Direct Discovery exist in EPS: Model A and Model B.

These two models may be (e.g., essentially) reused (e.g., as the same mechanism used in EPS) in NRE or the 5GC or 5GS. Alternatively or in addition, the Model A and the Model B may be defined according to clause 5.3.1.2 of the 3GP document TS 23.303, version 16.0.0.

Any of radio devices (e.g., UEs) may be registered with, authorized by, and/or provisioned by the RAN or a core network (CN) of the RAN. Since the functionality of the CN may be available to the UEs though the RAN, the description may refer to the RAN (instead of the CN) for brevity.

Any implementation of the methods 200-RD and 200-NN may comprise at least one of the following procedures for registration, authorization, and/or provision.

For the direct discovery authorization and provision to the UE 100-RD, an Application Function (AF) may provide the group information and/or the service information to the Policy Control Function (PCF) via a Network Exposure Function (NEF), and/or the PCF provides the authorization to the UE 100-RD according to the received information from the AF.

The authorization and provision procedures in clauses 6.2.2 and 6.2.5 of 3GPP document TS 23.287, version 16.4.0, (“Architecture enhancements for κG System (5GS) to support Vehicle-to-Everything (V2X) services”) may be reused to provide at least one of the following configurations:

A first configuration comprises the AF request sent to the PCF (or via NEF). The AF request may contain at least one of the following pieces of information. A first piece of information is the service information to be directly discovered over PC5 interface.

The service information can contain, e.g. Application identifier. A second piece of information comprises the group information (e.g. the external group identifier) to be directly discovered over PC5 interface. A third piece of information comprises the information can per announcing and/or monitoring direction (e.g., for the Model A) or per discoverer UE and/or discoveree UE (e.g., for Model B). A fourth piece of the information comprises the area information, e.g. geographical information (longitude and/or latitude and/or zip code, etc.).

Optionally, metadata information may be transmitted to the UE 100-RD (e.g., to configure the UE 100-RD) and/or the size of metadata, e.g., as part of discovery over PC5, may be transmitted to the UE.

A second configuration comprises the provision to the UE from the PCF, which may contain at least one of the following pieces of information, e.g., based on the information received from the AF and/or a local policy: A first piece of the information comprises the service information to be directly discovered over PC5 interface. The service information may contain, e.g., an application identifier. A second piece of the information comprises a group information (e.g. the external group identifier) to be directly discovered over PC5 interface. A third piece of the information comprises the area information used for direct discovery over PC5 interface. A fourth piece of the information comprises an area information, e.g., a list of geographical tracking areas (TAs). Optionally, the PCF may map the area information provided by AF to a list of TAs. A fifth piece of the information comprises security parameters used for direct discovery over PC5.

Uu RAT restriction is not applied to PC5 operations for the UE. Uu RAT information is not needed to be provisioned in the UE, e.g. to authorize the UE to send or monitor direct discovery message only when the UE camps on NR.

If the AMF determines the UE is authorized to use direct discovery based on the authorized area information, the AMF provides the UE, which is authorized to use direct discovery over PC5 interface to corresponding NG-RAN during N2 establishment for the UE.

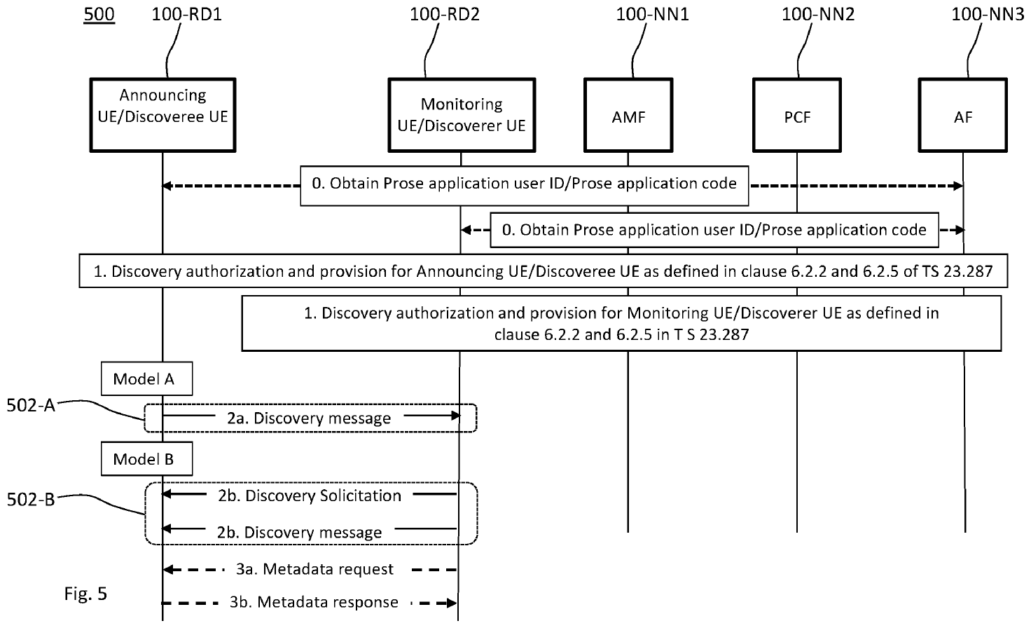

FIG. 5 shows a schematic signaling diagram resulting from embodiments of the devices of FIGS. 1A and 1B performing implementations of the methods of 2A and 2B

The discovery procedure may be implemented in accordance with or as an extension of the 3GPP document TR 23.752.

Registration, authorization, and/or provision may comprise at least one of the following steps.

In a step 0, the UE (also referred to as user) may obtain ProSe application user ID and ProSe application code for ProSe direct discovery using application layer mechanisms. The application layer in the UE provides application user ID and the application identifier to the ProSe Application Function. The ProSe Application Function allocates a ProSe application user ID and ProSe application code to the application layer in the U E.

The step 0 may be only needed for the applications for which there is privacy issue.

In a step 1, the UE obtains the authorization and provision for announcing discovery and/or for monitoring discovery and/or solicitation discovery, e.g., as defined in clauses 6.2.2 and 6.2.5 of the 3GPP document TS 23.287.

In a step 2a, when the announcing UE 100-RD is triggered e.g. by an upper layer application to announce availability for interested groups and/or for interested applications, if the UE 100-RD is authorized to perform the announcing UE procedure for the interested groups and/or the interested applications in step 1, then the UE 100-RD shall generate a PC5 direct discovery message according to the step 502-A for announcement, and optionally includes the following information in this message. The announcing UE 100-RD computes a security protection element (e.g. for integrity protection) and appends it to the PC5 message:
1) ProSe UE ID e.g. ProSe application user ID, Layer 2 ID.
2) The group ID(s) provided by the application layer.
3) The application ID(s) or ProSe application code(s) provided the application layer.

When the monitoring UE 100-RD is triggered to perform the direct discovery 202-RD, e.g. by an upper layer application or by the user to monitor proximity of other UEs 200-RD for the interested group(s) and/or interested applications, and if the UE is authorized to perform the monitoring procedure for the group(s) and/or applications, then the UE monitors the discovery message.

The monitoring UE 100-RD verifies the security protection element using the provisioned security parameters corresponding to the application. If the verification of the security protection element succeeds, the service is successfully discovered by the monitoring UE 100-RD. The monitoring UE 100-RD may then notify the application layer using the result of the discovery 202-RD.

In a step 2b, when the discoverer UE 100-RD is triggered to perform the direct discovery 202-RD, e.g. by an upper layer application or by the user to discover other UEs 100-RD for the interested group(s) and/or interested applications, and if the UE 100-RD is authorized to perform the discovery solicitation procedure for the group(s) and/or applications in step 1, then the UE 100-RD sends a solicitation message with the information of at least one of discoverer ProSe UE ID, application ID(s) or ProSe application code(s), group ID(s). The discoverer UE 100-RD computes a security protection element (e.g. for integrity protection) and appends it to the PC5 message.

If the discoveree UE 100-RD is able to and/or authorized to respond to the discovery solicitation according to the received information in the solicitation message, then it responds to the discovery message with the discoveree ProSe UE ID, the supported application ID(s) or ProSe application code(s) and group ID(s).

In a step 3a, if the monitoring UE 100-RD and/or the discoverer UE 100-RD wants to request metadata corresponding to the discovered service in step 2, the monitoring UE 100-RD and/or the discoverer UE 100-RD may send a unicast metadata request message to request discovery metadata. The monitoring UE/discoverer UE may use the Layer 2 ID of announcing UE/discoveree UE (received in step 2a or 2b) to send the Metadata Request message.

In a step 3b, the announcing UE 100-RD and/or the discoveree UE 100-RD responds with a Metadata Response message. The announcing UE/discoveree UE includes the metadata information in the Metadata Response message.

Any one of the embodiments described herein may be applicable to both a direct device to device (D2D) communication (i.e., without relay), and a device to device communication via a relay node (e.g., a relay radio device). The embodiments are described in the context of NR, i.e., remote UE and relay UE are deployed in a same or different NR cells.

Any one of the embodiments described herein may also be applicable to other relay scenarios including UE to network (U2N) relay or UE to UE (U2U) relay, in which cases the link (i.e., the relayed radio communication) between the remote UE 100-RD and relay UE 100-Rd may be based on LTE sidelink or NR sidelink. Moreover, the Uu connection between relay UE 100-RD and the base station 100-NN may be LTE Uu or NR Uu.

A relay scenario containing multiple relay hops is also covered. The connection between remote UE and relay UE is also not limited to sidelink (SL), e.g., in the definition of 3GPP. Any short-range communication technology such as Wi-Fi is equally applicable (and collectively referred to as SL).

The embodiments are also applicable to a relay scenario, in which the relay UE 100-RD is configured with multiple connections (i.e., the number of connections is equal or larger than two) to the RAN (e.g., dual connectivity, carrier aggregation etc.).

The embodiments are applicable to both L2 relay and L3 relay-based relay scenarios.

Any embodiment of the technique may be implemented alone or in combination with at least one of the following embodiments and/or options.

In the first embodiment, when a discovery procedure is triggered by a UE 100-RD (e.g., remote UE or relay UE), the UE 100-RD is configured to apply only one of the discovery models. The model selection rule may be pre-configured or signaled by a gNB or a controlling UE, via at least one of the below signaling alternatives:
RRC signaling (Uu RRC or PC5-signaling),
MAC CE,
L1 signaling (e.g., PDCCH, RACH and/or SCI, etc.), and
control PDU of a protocol layer such as SDAP, PDCP, RLC or adaptation layer.

The selection rule of discovery model can also be configured by the PCF during the UE registration to the network. For PCF based Service Authorization and Provisioning to UE, the Registration procedures as defined in clause 4.2.2.2 of 3GPP document TS 23.502, version 16.6.0, AMF gets the model selection rule from the PCF via Npcf_UEPolicyControl_Create service. UE Policy Association Establishment procedure is defined in clause 4.16.11 of the 3GPP document TS 23.502, version 16.6.0.

In the second embodiment, when a discovery procedure is triggered by a UE (i.e., remote UE or relay UE), the UE is configured to support all available discovery models. The UE may apply at least one of the below options to determine which discovery model to be used.

According to a first option, e.g., of the second embodiment, upon trigger of a discovery event, the UE 100-RD starts to apply a discovery model according to the step 202-RD for a configured time period. If there are no expected discovery messages (e.g., discovery announcement or discovery response message) received by the UE, the UE 100-RD switches to a different discovery model.

According to a second option, e.g., of the second embodiment, each discovery model is mapped to specific discovery occasions (DOs). A discovery occasion (DO) is an area specified in time and frequency domain that are available for the transmission or reception of a discovery message. This term is just an example.

Similar terms are interchangeable applicable.

Upon trigger of a discovery event, the UE 100-RD does nothing until a subsequent DO is available, then the UE 100-RD determines the discovery model based on the mapping relation between the DO and the discovery model.

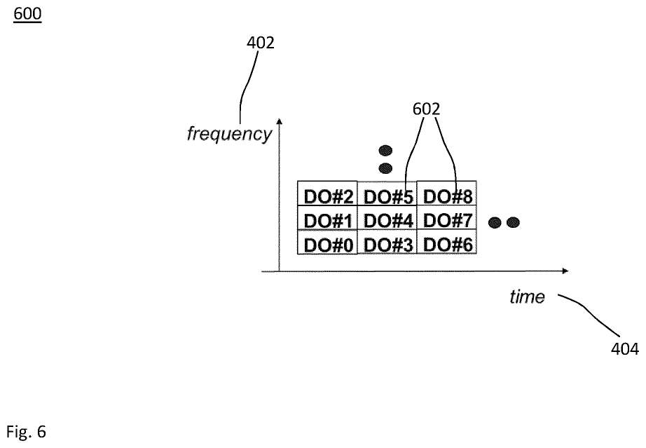

FIG. 6 schematically illustrates DOs 602 in the time and frequency domain 600. This structure may be implemented with any embodiment disclosed herein. In other words, FIG. 6 shows an example of a resource region containing DOs 602.

As a non-limiting example of the DOs (e.g., used in the second option of the second embodiment mentioned above), the overall mapping logic (i.e., the association) between DOs 602 and the at least two different models is descried below.

The DOs 602 are numbered, firstly, in increasing order of frequency resource indexes 402, e.g., for frequency multiplexed DOs 602. Alternatively or secondly, the DOs 602 are numbered in increasing order of time resource indexes 404, e.g., for time multiplexed DOs 602 within a discovery slot (i.e., assuming a scheduling slot contains multiple DOs in time). Alternatively or secondly or thirdly, the DOs 602 are numbered in increasing order of indexes for discovery slots.

A discovery slot may be configured (e.g., by the network node 100-NN) in the time domain to contain multiple DOs 602 in time 404. A discovery slot may be equal to one or multiple normal slots, or X OFDM symbols in time 404, e.g., for X being equal to 1 or greater than 1.

Alternatively or in addition, the DOs 602 may have the same or different time durations.

Alternatively or in addition, the DOs 602 may be consecutively or non-consecutively distributed in frequency 402 and/or in time 402.

Optionally, each number of the DOs 602 may be mapped or may correspond to one of the models of the direct discovery.

The UE 100-RD then further initiates a corresponding discovery procedure according to the model, e.g., determined based on the current DO 602.

If the discovery procedure cannot be completed successfully until the next DO is available, the UE 100-RD may change to a different discovery model and initiates another discovery procedure.

According to a third option, e.g., of the second embodiment, upon trigger of a discovery event, the UE 100-RD initiates a first discovery procedure corresponding to a discovery model according to the step 202-RD.

While the first discovery procedure is running, the UE 100-RD may initiate a second discovery procedure according to another model. Thus, the two procedures may partly overlap in time.

The UE 100-RD may receive discovery messages for at least one of the procedures. The UE 100-RD may select one of the discovery procedures, i.e., selection of one or both procedures to find target UEs 100-RD, e.g., based on the receive discovery messages.

In an example, for a remote UE 100-RD, in case the remote UE has received results of a (e.g., target) relay UE 100-RD by both procedures, the remote UE 100-RD may select the best target relay UE 100-RD from results provided by both procedures, e.g., by comparing the results (e.g., responses) of the first and second discovery procedures.

For example, the remote UE 100-RD sends a Solicitation message to discover a relay UEs 100-RD and gets Response messages from at least two (e.g., candidate and/or target) relay UEs 100-RD. In the meanwhile, the remote UE 100-RD may also receive the Announcement messages from the at least two relay UEs 100-RD.

In an example, for a relay UE 100-RD, in case the relay UE 100-RD has received results of target remote UEs by both procedures, the relay UE 100-RD can select a target remote UE 100-RD from results provided by both procedures.

This example may be applied in case that a transmitting node (e.g., a network node 100-NN such as a gNB or a radio device 100-RD such as a UE) has data intended for a destination remote UE 100-RD, however that target remote UE 100-RD is not within its coverage area, in this case, the transmitting node 100-NN or 100-RD may first search for a relay UE 100-RD, the selected relay UE 100-RD may further reach the destination remote UE 100-RD. In this case, the selected relay UE 100-RD may need to initiate a discovery procedure towards the destination remote UE 100-RD.

According to a fourth option, e.g., of the second embodiment, upon trigger of a discovery event, the UE 100-RD initiates at least two discovery procedures in parallel, each of the discovery procedures 202-ED corresponding to a different one of the at least two discovery models. Thus, these procedures may fully overlap in time.

The UE 100-RD may receive discovery messages for or in at least one of the discovery procedures. The UE 100-RD selects at least one of the parallel discovery procedures, i.e., selection of one or both or all procedures to find target UEs.

The examples described in third option may also be valid for and/or applicable to and/or combined with the fourth option.

According to a fifth option, e.g., of the second embodiment, upon trigger of a discovery procedure, the UE 100-RD selects a discovery model based on at least one of the following conditions (e.g., comprising one or more criteria).

According to a first condition, the one model for the step 202-RD is selected out of the at least two different models based on or depending on a service and/or an application which triggered the discovery event. For example, the one model may be selected depending on whether the one or more services are delay sensitive or delay insensitive. For instance, model A may be based on periodic transmissions, meaning that it may not be able to achieve a fast discovery. While the UE 100-RD can start the discovery according to the model B immediately upon trigger of the discovery event. In this way, the UE 100-RD may be able to achieve a fast discovery.

According to a second condition, the one model for the step 202-RD is selected out of the at least two different models based on or depending on a purpose of the discovery event. For example, the purpose may comprise finding one or more services or applications in proximity to the UE 100-RD, or the purpose may comprise finding a target UE for direct UE to UE communication, or the purpose may comprise finding a target UE to establish a relay connection. For instance, each (e.g., specific) purpose of the discovery may be associated with a different discovery model.

According to a third condition, the one model for the step 202-RD is selected out of the at least two different models depending on a UE category of the UE 100-RD performing the step 202-RD. For example, depending on the UE category, one or multiple discovery models may be supported.

According to a fourth condition, the one model for the step 202-RD is selected out of the at least two different models depending on a UE battery lifetime. For instance, discovery Model A may consume more power, since the UE 100-RD may have to transmit the discovery announcement repeatedly, while Mode B may consume less power, since the UE 100-RD may just perform a single (or one-shot) transmission of the discovery message.

According to a fifth condition, the one model for the step 202-RD is selected out of the at least two different models depending on a occupancy of the channel for the direct discovery, e.g., whether or not it is a busy time. For instance, the Model B may be suitable to be applied during a busy time, while the Model A may be suitable to be applied during non-busy times.

According to a fifth condition, the one model for the step 202-RD is selected out of the at least two different models depending on a status of the system load in proximity. For instance, Model B may be suitable to be applied in case of high system load, while Model A may be suitable to be applied in case of low system loads.

According to a fifth condition, the one model for the step 202-RD is selected out of the at least two different models depending on a location or area where the UE has triggered the discovery event. For instance, each area or location may be associated with a different discovery model. This may be relevant for scenario of public safety (e.g., firefighters' squad) that is located in a specific area and/or where all the devices in that specific area know that there is a common interest for a specific type of service and/or application and/or traffic.

According to a sixth option, e.g., of the second embodiment, the UE 100-RD chooses a certain discovery model to be used based on the frequency on which the sidelink (e.g., the channel of the ProSe) is operating. The mapping between the sidelink frequency and the related discovery model can be pre-configured and/or hardcoded (e.g., according to a specification) or it can be decided by the RAN (e.g., the configured by the network node 100-NN such as an gNB). The gNB 100-NN may inform the relay UE 100-RD and/or the remote UE 100-RD about this mapping via dedicated RRC signaling or via system information (i.e., SIB).

Which option that the UE should apply, may be defined (e.g., according to a specification) in a hard-coded manner, or configured by the RAN (e.g., the network node 100-NN such as a gNB) or a controlling UE 100-RD via at least one of the following signaling alternatives: RRC signaling (e.g., Uu RRC or PC5-signaling), MAC CE, L1 signaling (e.g., PDCCH, RACH, and/or SCI etc.), a control PDU of a protocol layer such as SDAP, PDCP, RLC and/or adaptation layer.

The option selection rule can also be configured by the PCF during the UE registration to the network. For PCF based Service Authorization and Provisioning to UE, the Registration procedures as defined in clause 4.2.2.2 of 3GPP document TS 23.502, AMF gets the option selection rule from the PCF via Npcf_UEPolicyControl_Create service. UE Policy Association Establishment procedure is defined in clause 4.16.11 of 3GPP document TS 23.502.

At least one of the options 1 to 6 may be combined with any of the embodiments disclosed herein, e.g., with any one of the claims.

In a third embodiment, one UE capability bit is defined for a UE indicating whether the UE supports a specific discovery model. There may be multiple UE capability bits defined for a UE in case multiple discovery models are feasible to apply.

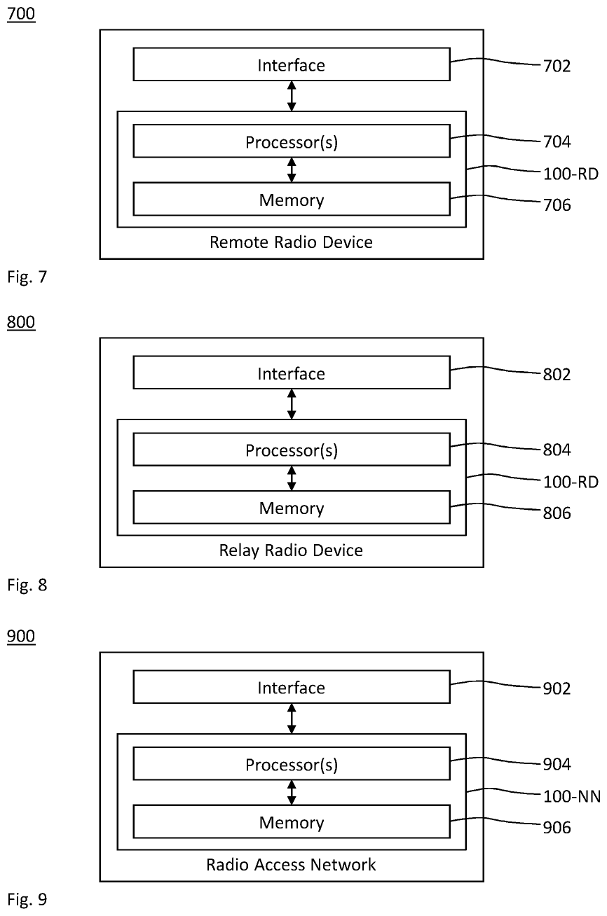

FIG. 7 shows a schematic block diagram for an embodiment of the device 100-RD. The device 100-RD comprises processing circuitry, e.g., one or more processors 804 for performing the method 200-RD and memory 806 coupled to the processors 804. For example, the memory 806 may be encoded with instructions that implement at least one of the modules 102-RD and 104-RD.

The one or more processors 804 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100-RD, such as the memory 806, radio device (e.g., UE) functionality, e.g., remote radio device functionality. For example, the one or more processors 804 may execute instructions stored in the memory 806. Such functionality may include providing various features and steps discussed herein, including any of the benefits disclosed herein. The expression “the device being operative to perform an action” may denote the device 100-RD being configured to perform the action.

As schematically illustrated in FIG. 8, the device 100-RD may be embodied by a remote radio device 800, e.g., functioning as a remote UE. The remote UE 800 comprises a radio interface 802 coupled to the device 100-RD for radio communication with one or more radio devices, e.g., functioning as another UE 100-RD, optionally a relay UE 100-RD.

FIG. 8 shows a schematic block diagram for an embodiment of the device 100-RD. The device 100-RD comprises processing circuitry, e.g., one or more processors 804 for performing the method 200-RD and memory 806 coupled to the processors 804. For example, the memory 806 may be encoded with instructions that implement at least one of the modules 102-RD and 104-RD.

The one or more processors 804 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100-RD, such as the memory 806, radio device (e.g., UE) functionality, e.g., relay radio device functionality. For example, the one or more processors 804 may execute instructions stored in the memory 806. Such functionality may include providing various features and steps discussed herein, including any of the benefits disclosed herein. The expression “the device being operative to perform an action” may denote the device 100-RD being configured to perform the action.

As schematically illustrated in FIG. 8, the device 100-RD may be embodied by a relay radio device 800, e.g., functioning as a relay UE. The relay UE 800 comprises a radio interface 802 coupled to the device 100-RD for radio communication with one or more radio devices, e.g., functioning as another UE 100-RD, optionally a remote UE 100-RD.

FIG. 9 shows a schematic block diagram for an embodiment of the device 100-NN. The device 200 comprises processing circuitry, e.g., one or more processors 904 for performing the method 200-NN and memory 906 coupled to the processors 904. For example, the memory 906 may be encoded with instructions that implement at least one of the modules 102-NN and 104-NN.

The one or more processors 904 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 906, network node (e.g., base station) functionality. For example, the one or more processors 904 may execute instructions stored in the memory 906. Such functionality may include providing various features and steps discussed herein, including any of the benefits disclosed herein. The expression “the device being operative to perform an action” may denote the device 100-NN being configured to perform the action.

As schematically illustrated in FIG. 9, the device 100-NN may be embodied by a network node 900, e.g., functioning as a base station of the RAT. The base station 900 comprises a radio interface 902 coupled to the device 100-NN for radio communication with one or more radio devices, e.g., functioning as UEs 100-RD.

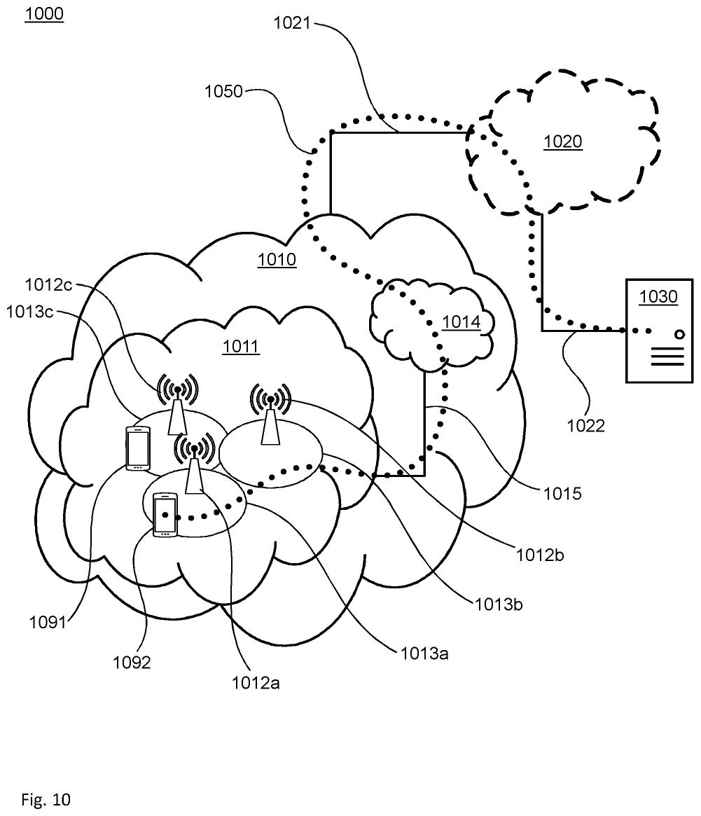

With reference to FIG. 10, in accordance with an embodiment, a communication system 1000 includes a telecommunication network 1010, such as a 3GPP-type cellular network, which comprises an access network 1011, such as a radio access network, and a core network 1014. The access network 1011 comprises a plurality of base stations 1012a, 1012b, 1012c, such as NBs, eNBs, gNBs or other types of wireless access points, each defining a corresponding coverage area 1013a, 1013b, 1013c. Each base station 1012a, 1012b, 1012c is connectable to the core network 1014 over a wired or wireless connection 1015. A first user equipment (UE) 1091 located in coverage area 1013c is configured to wirelessly connect to, or be paged by, the corresponding base station 1012c. A second UE 1092 in coverage area 1013a is wirelessly connectable to the corresponding base station 1012a. While a plurality of UEs 1091, 1092 are illustrated in this example, the disclosed embodiments are equally applicable to a situation where a sole UE is in the coverage area or where a sole UE is connecting to the corresponding base station 1012.

Any of the base stations 1012 and the UEs 1091, 1092 may embody the device 100.

The telecommunication network 1010 is itself connected to a host computer 1030, which may be embodied in the hardware and/or software of a standalone server, a cloud-implemented server, a distributed server or as processing resources in a server farm. The host computer 1030 may be under the ownership or control of a service provider, or may be operated by the service provider or on behalf of the service provider. The connections 1021, 1022 between the telecommunication network 1010 and the host computer 1030 may extend directly from the core network 1014 to the host computer 1030 or may go via an optional intermediate network 1020. The intermediate network 1020 may be one of, or a combination of more than one of, a public, private or hosted network; the intermediate network 1020, if any, may be a backbone network or the Internet; in particular, the intermediate network 1020 may comprise two or more sub-networks (not shown).

The communication system 1000 of FIG. 10 as a whole enables connectivity between one of the connected UEs 1091, 1092 and the host computer 1030. The connectivity may be described as an over-the-top (OTT) connection 1050. The host computer 1030 and the connected UEs 1091, 1092 are configured to communicate data and/or signaling via the OTT connection 1050, using the access network 1011, the core network 1014, any intermediate network 1020 and possible further infrastructure (not shown) as intermediaries. The OTT connection 1050 may be transparent in the sense that the participating communication devices through which the OTT connection 1050 passes are unaware of routing of uplink and downlink communications. For example, a base station 1012 need not be informed about the past routing of an incoming downlink communication with data originating from a host computer 1030 to be forwarded (e.g., handed over) to a connected UE 1091.

Similarly, the base station 1012 need not be aware of the future routing of an outgoing uplink communication originating from the UE 1091 towards the host computer 1030.

By virtue of the method 200-RD being performed by any one of the UEs 1091 or 1092 and/or any one of the base stations 1012, the performance or range of the OTT connection 1050 can be improved, e.g., in terms of increased throughput and/or reduced latency. More specifically, the host computer 1030 may indicate to the RAN 300, 900, 1010, or 1120, or the relay radio device 200-RD or the remote radio device 100-RD (e.g., on an application layer) the model to be used for the direct discovery 202-RD.

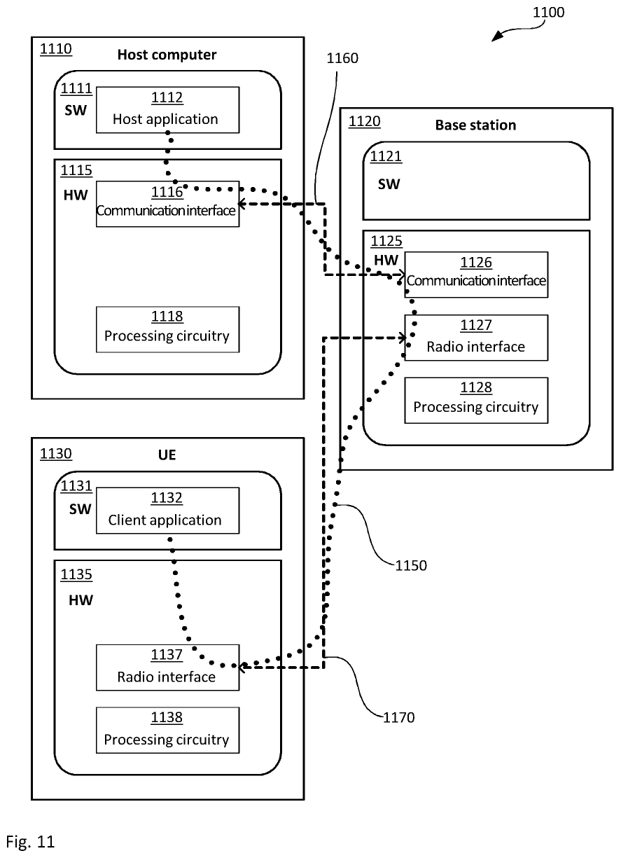

Example implementations, in accordance with an embodiment of the UE, base station and host computer discussed in the preceding paragraphs, will now be described with reference to FIG. 11. In a communication system 1100, a host computer 1110 comprises hardware 1115 including a communication interface 1116 configured to set up and maintain a wired or wireless connection with an interface of a different communication device of the communication system 1100. The host computer 1110 further comprises processing circuitry 1118, which may have storage and/or processing capabilities. In particular, the processing circuitry 1118 may comprise one or more programmable processors, application-specific integrated circuits, field programmable gate arrays or combinations of these (not shown) adapted to execute instructions. The host computer 1110 further comprises software 1111, which is stored in or accessible by the host computer 1110 and executable by the processing circuitry 1118. The software 1111 includes a host application 1112. The host application 1112 may be operable to provide a service to a remote user, such as a UE 1130 connecting via an OTT connection 1150 terminating at the UE 1130 and the host computer 1110. In providing the service to the remote user, the host application 1112 may provide user data, which is transmitted using the OTT connection 1150. The user data may depend on the location of the UE 1130. The user data may comprise auxiliary information or precision advertisements (also: ads) delivered to the UE 1130. The location may be reported by the UE 1130 to the host computer, e.g., using the OTT connection 1150, and/or by the base station 1120, e.g., using a connection 1160.

The communication system 1100 further includes a base station 1120 provided in a telecommunication system and comprising hardware 1125 enabling it to communicate with the host computer 1110 and with the UE 1130. The hardware 1125 may include a communication interface 1126 for setting up and maintaining a wired or wireless connection with an interface of a different communication device of the communication system 1100, as well as a radio interface 1127 for setting up and maintaining at least a wireless connection 1170 with a UE 1130 located in a coverage area (not shown in FIG. 11) served by the base station 1120. The communication interface 1126 may be configured to facilitate a connection 1160 to the host computer 1110. The connection 1160 may be direct, or it may pass through a core network (not shown in FIG. 11) of the telecommunication system and/or through one or more intermediate networks outside the telecommunication system. In the embodiment shown, the hardware 1125 of the base station 1120 further includes processing circuitry 1128, which may comprise one or more programmable processors, application-specific integrated circuits, field programmable gate arrays or combinations of these (not shown) adapted to execute instructions. The base station 1120 further has software 1121 stored internally or accessible via an external connection.

The communication system 1100 further includes the UE 1130 already referred to. Its hardware 1135 may include a radio interface 1137 configured to set up and maintain a wireless connection 1170 with a base station serving a coverage area in which the UE 1130 is currently located. The hardware 1135 of the UE 1130 further includes processing circuitry 1138, which may comprise one or more programmable processors, application-specific integrated circuits, field programmable gate arrays or combinations of these (not shown) adapted to execute instructions. The UE 1130 further comprises software 1131, which is stored in or accessible by the UE 1130 and executable by the processing circuitry 1138. The software 1131 includes a client application 1132. The client application 1132 may be operable to provide a service to a human or non-human user via the UE 1130, with the support of the host computer 1110. In the host computer 1110, an executing host application 1112 may communicate with the executing client application 1132 via the OTT connection 1150 terminating at the UE 1130 and the host computer 1110. In providing the service to the user, the client application 1132 may receive request data from the host application 1112 and provide user data in response to the request data. The OTT connection 1150 may transfer both the request data and the user data. The client application 1132 may interact with the user to generate the user data that it provides.

It is noted that the host computer 1110, base station 1120 and UE 1130 illustrated in FIG. 11 may be identical to the host computer 1030, one of the base stations 1012a, 1012b, 1012c and one of the UEs 1091, 1092 of FIG. 10, respectively. This is to say, the inner workings of these entities may be as shown in FIG. 11, and, independently, the surrounding network topology may be that of FIG. 10.

In FIG. 11, the OTT connection 1150 has been drawn abstractly to illustrate the communication between the host computer 1110 and the UE 1130 via the base station 1120, without explicit reference to any intermediary devices and the precise routing of messages via these devices. Network infrastructure may determine the routing, which it may be configured to hide from the UE 1130 or from the service provider operating the host computer 1110, or both. While the OTT connection 1150 is active, the network infrastructure may further take decisions by which it dynamically changes the routing (e.g., on the basis of load balancing consideration or reconfiguration of the network).

The wireless connection 1170 between the UE 1130 and the base station 1120 is in accordance with the teachings of the embodiments described throughout this disclosure. One or more of the various embodiments improve the performance of OTT services provided to the UE 1130 using the OTT connection 1150, in which the wireless connection 1170 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 1150 between the host computer 1110 and UE 1130, in response to variations in the measurement results. The measurement procedure and/or the network functionality for reconfiguring the OTT connection 1150 may be implemented in the software 1111 of the host computer 1110 or in the software 1131 of the UE 1130, or both. In embodiments, sensors (not shown) may be deployed in or in association with communication devices through which the OTT connection 1150 passes; the sensors may participate in the measurement procedure by supplying values of the monitored quantities exemplified above, or supplying values of other physical quantities from which software 1111, 1131 may compute or estimate the monitored quantities. The reconfiguring of the OTT connection 1150 may include message format, retransmission settings, preferred routing etc.; the reconfiguring need not affect the base station 1120, and it may be unknown or imperceptible to the base station 1120. Such procedures and functionalities may be known and practiced in the art. In certain embodiments, measurements may involve proprietary UE signaling facilitating the host computer's 1110 measurements of throughput, propagation times, latency and the like. The measurements may be implemented in that the software 1111, 1131 causes messages to be transmitted, in particular empty or “dummy” messages, using the OTT connection 1150 while it monitors propagation times, errors etc.

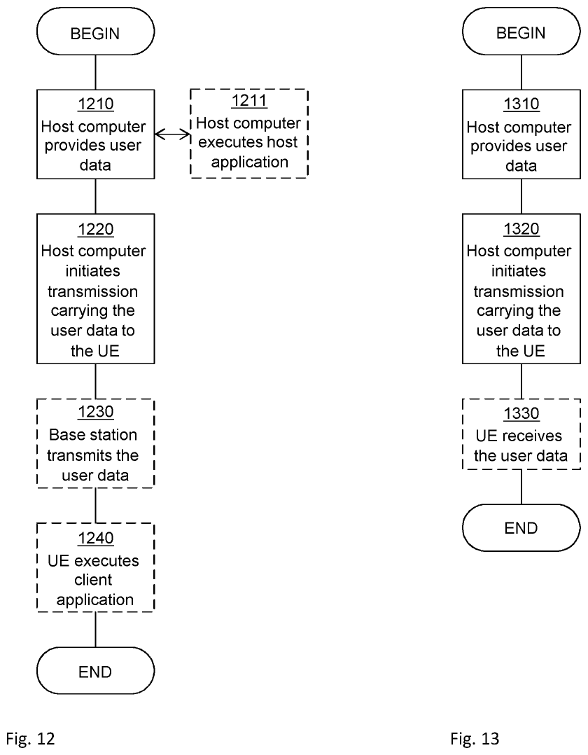

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this paragraph. In a first step 1210 of the method, the host computer provides user data. In an optional substep 1211 of the first step 1210, the host computer provides the user data by executing a host application. In a second step 1220, the host computer initiates a transmission carrying the user data to the UE. In an optional third step 1230, the base station transmits to the UE the user data which was carried in the transmission that the host computer initiated, in accordance with the teachings of the embodiments described throughout this disclosure. In an optional fourth step 1240, the UE executes a client application associated with the host application executed by the host computer.

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this paragraph. In a first step 1310 of the method, the host computer provides user data. In an optional substep (not shown) the host computer provides the user data by executing a host application. In a second step 1320, the host computer initiates a transmission carrying the user data to the UE. The transmission may pass via the base station, in accordance with the teachings of the embodiments described throughout this disclosure. In an optional third step 1330, the UE receives the user data carried in the transmission.

As has become apparent from above description, at least some embodiments of the technique improve the latency, power consumption and signaling overhead by performing the discovery procedure, e.g., in a UE-to-NW and UE-to-UE relay scenarios. For example, the reduced latency is vital vehicular communications (V2X). Furthermore, the reduced power consumption and improved radio resource efficiency can be decisive for maintaining service in critical situations, e.g., when the requirements on public safety and V2X use cases need to be met.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1. A method of performing direct discovery between a first radio device and a second radio device according to a proximity service of a radio access technology, RAT, wherein the proximity service comprises at least two different models of the direct discovery, the method comprising or initiating:
performing the direct discovery according to one of the at least two different models;
receiving, at the first radio device, a configuration message, wherein the configuration message is indicative of the one of the at least two different models to be used for the performing of the direct discovery, or wherein the configuration message is indicative of a selection rule, the method further comprising:
selecting, at the first radio device, the one of the at least two different models to be used for the performing of the direct discovery according to the selection rule.

2. The method of claim 1, wherein the performing of the direct discovery further comprises:
while the direct discovery is performed according to the one model, performing or initiating a further direct discovery according to another model out of the at least two different models, wherein the direct discovery and the further direct discovery are performed partly overlapping in time.

3. The method of claim 2, wherein the first radio device is an announcing radio device according to the proximity service and the second radio device is a monitoring radio device according to the proximity service, if the one of the different models is a first model, and/or
wherein the first radio device is a discoverer radio device according to the proximity service and the second radio device is a discoveree radio device according to the proximity service, if the one of the different models is a second model.

4. The method of claim 1, wherein at least one or each of the first radio device and the second radio device is configured to perform the direct discovery using exclusively the one of the at least two different models.

5. The method of claim 1, wherein the one of the at least two different models is pre-configured in at least one or each of the first radio device and the second radio device.

6. (canceled)

7. The method of claim 6, wherein the configuration message is received at the first radio device from the second radio device.

8. The method of claim 1, wherein at least one of the first radio device and the second radio device are in a radio-connected state with a radio access network, RAN.

9. The method of claim 1, wherein the configuration message is received, from the RAN, at the first radio device and/or at the second radio device.

10. The method of claim 1, wherein the configuration message is received, at the first radio device and/or at the second radio device, from a Policy Control Function, PCF, of the RAN or an Access and Mobility Management Function, AMF, of the RAN,
optionally wherein the configuration message is received at the first radio device upon registering the first radio device at the RAN.

11. The method of claim 1, wherein the first radio device is out of coverage of the RAN, and wherein the configuration message is received at the first radio device as relayed through the second radio device from the RAN.

12. The method of claim 1, wherein the configuration message comprises at least one of radio resource control (RRC) signaling; a medium access control, MAC, control element, CE; a control signal on a physical control channel; a control packet data unit, PDU, of a packet data convergence protocol, PDCP; a control PDU of a radio link control, RLC; a control PDU of a Service Data Adaptation Protocol, SDAP, defining or implying a quality of service, QoS, flow for the proximity service; and a control PDU of an adaptation layer relaying a radio communication through the first radio device or the second radio device using the proximity service.

13. The method of claim 1, wherein the performing of the direct discovery is triggered by at least one of the first radio device and the second radio device, optionally by an application layer of the first radio device or the second radio device.

14. The method of claim 1, wherein the method is performed by at least one or each of the first radio device and the second radio device.

15. The method of claim 1, wherein a result of the direct discovery comprises a match between the first radio device and the second radio device according to the proximity service, the method further comprising:
performing a direct communication between the first radio device and the second radio device according to the proximity service responsive to the match.

16. The method of claim 1, wherein performing at least one of the direct discovery and the direct communication comprises:
transmitting a message directly from the first radio device to the second radio device using the RAT; or
receiving a message directly from the first radio device at the second radio device using the RAT.

17. The method of claim 1, wherein the performing of the direct discovery comprises:
transmitting a discovery message directly from the first radio device to the second radio device according to the proximity service; or
receiving a discovery message directly from the first radio device at the second radio device according to the proximity service.

18. The method of claim 17, wherein the transmitting of the discovery message comprises unicasting and/or groupcasting an announcement according to a first model of the different models, and/or wherein an announcement is transmitted periodically according to the first model of the different models.

19. The method of claim 17, wherein the receiving of the discovery message comprises monitoring a channel of the proximity service for an announcement according to a first model of the different models.

20. The method of claim 18, wherein the announcement is indicative of information provided or retrievable by the first radio device.

21. The method of claim 17, wherein the transmitting of the discovery message comprises broadcasting or groupcasting the discovery message according to a second model of the different models.

22. The method of claim 21, wherein the receiving of the discovery message comprises monitoring a channel of the proximity service for a query code of the proximity service according to the second model.

23. The method of claim 21, wherein the discovery message is indicative of information required by the first radio device and/or requested from the second radio device.

24.-37. (canceled)

38. A method of controlling direct discovery between a first radio device and a second radio device according to a proximity service of a radio access technology, RAT, wherein the proximity service comprises at least two different models of the direct discovery, the method comprising or initiating:
transmitting a configuration message from the RAN to at least one of the first radio device and the second radio device, the configuration message being indicative of one of the at least two different models to be used in the direct discovery or a selection rule for selecting one of the at least two different models to be used in the direct discovery.

39. The method of claim 38, further comprising or initiating:
transmitting a scheduling message from the RAN to at least one of the first radio device and the second radio device, the scheduling message being indicative of radio resources to be used in at least one of the direct discovery or a direct communication resulting from a match determined in the direct discovery.

40.-41. (canceled)

42. A radio device for performing direct discovery between a first radio device and a second radio device according to a proximity service of a radio access technology, RAT, wherein the proximity service comprises at least two different models of the direct discovery, the radio device comprising memory operable to store instructions and processing circuitry operable to execute the instructions, such that the radio device is operable to:
perform the direct discovery according to one of the at least two different models;
receive, at the first radio device, a configuration message, wherein the configuration message is indicative of the one of the at least two different models to be used for the performing of the direct discovery, or wherein the configuration message is indicative of a selection rule; and
select, at the first radio device, the one of the at least two different models to be used for the performing of the direct discovery according to the selection rule.

43.-45. (canceled)

46. A user equipment, UE for performing direct discovery between a first radio device and a second radio device according to a proximity service of a radio access technology, RAT, wherein the proximity service comprises at least two different models of the direct discovery, the UE being configured to communicate with a base station or with a radio device functioning as a gateway, the UE comprising a radio interface and processing circuitry configured to:
perform the direct discovery according to one of the at least two different models;
receive, at the first radio device, a configuration message, wherein the configuration message is indicative of the one of the at least two different models to be used for the Performing of the direct discovery, or wherein the configuration message is indicative of a selection rule; and
select, at the first radio device, the one of the at least two different models to be used for the performing of the direct discovery according to the selection rule.

47.-58. (canceled)
